(19) United States
(12) Patent Application Publication
(10) Pub. No.: US 2002/0117031 A1
(43) Pub. Date: Aug. 29, 2002

(54) Rotatable positioning apparatus for cutting timbers

(76) Inventor: David Mills, Lyons, CO (US)

Correspondence Address: EMERY L. TRACY, P.O. Box 1518, Boulder, CO, 80306, US

(21) Appl. No.: 09/792,512

(22) Filed: Feb. 23, 2001

(51) Int. Cl. B26D 3/02

(52) U.S. Cl. 83/13; 83/581

(57) ABSTRACT

A rotatable positioning apparatus for cutting timbers to a predetermined length and a predetermined angle is provided. The rotatable positioning apparatus supports a saw. The rotatable positioning apparatus comprises a base frame and a rotatable turntable mounted to the base frame. A support frame is mounted to the rotatable turntable with the support frame having a predetermined length. A saw-supporting frame is movable along the length of the support frame with the saw being secured to the supporting frame. A locking mechanism releasably secures the rotatable turntable in a predetermined position relative to the base frame.

### BACKGROUND OF THE INVENTION

1. Field of the Invention

This invention relates generally to an apparatus for cutting timbers and, more particularly, it relates to a rotatable positioning apparatus for cutting timbers and logs for homes and furniture and any other type of wood product to proper length and angles.

2. Description of the Prior Art

Timber framing is increasingly becoming a popular design feature for many homes. It is important that the finished length of the timber work be accurate, and also that the bevel angles at each end of the work be accurate, and finally that the position of each apex of the timber work in relation to the sides of the work be accurately maintained.

In the past, the timbers were supported on a table with a portion of the timber overhanging or cantilevered over the end of the table. The craftsperson would then make the appropriate measurements and markings depending on the position of the timber in the home and the position of the timber relative to the other timbers in the home. Once these measurements and markings have been made, the craftsperson, using a skill saw or other appropriate tool, will make the cuts to size the timber and construct the appropriate bevel angle. This amounts to a very time consuming, labor-intensive project that directly affects the cost of constructing a timber framed home.

Accordingly, there exists a need for an apparatus for cutting timbers which reduces the time necessary to cut and size the timbers. Additionally, a need exists for an apparatus which accurately cuts and sizes the timbers for use in timber-framed homes. Furthermore, there exists a need for a rotatable positioning apparatus which allows a craftsperson to cut and size timbers with minimal effort and time. In addition, a need exists for a rotatable positioning apparatus having the ability to rotate in a substantially circular direction and move in a substantially linear direction for use in traditional timber framing of homes and other structures.

### SUMMARY

The present invention is a rotatable positioning apparatus for cutting timbers to a predetermined length and a predetermined angle, the rotatable positioning apparatus supporting a saw, the rotatable positioning apparatus comprising a base frame and a rotatable turntable mounted to the base frame. A support frame is mounted to the rotatable turntable with the support frame having a predetermined length. A saw-supporting frame is movable along the length of the support frame with the saw being secured to the supporting frame. A locking mechanism releasably secures the rotatable turntable in a predetermined position relative to the base frame.

The present invention additionally includes an assembly for cutting a timber or other wood product to a predetermined length and angle. The assembly comprises a rotatable turntable movable in a substantially circular manner. Rail means are mounted to the rotatable turntable and saw means are movable along the rail means for performing at least one cut on the timber at the predetermined length and angle wherein the saw means are movable in a substantially circular manner and a substantially linear manner relative to the timber.

The present invention further includes a method for cutting a stationary timber to a predetermined length and angle. The method comprises providing a rotatable turntable movable in a substantially circular manner, providing a parallel rail track, mounting the parallel rail track to the rotatable turntable, providing a saw mechanism movable along the rail means, moving the saw mechanism in a substantially circular manner, moving the saw mechanism in a substantially linear manner, and for performing at least one cut on the timber at the predetermined length and angle.

### BRIEF DESCRIPTION OF THE DRAWINGS

FIG. 1 is an elevational side view illustrating a rotatable positioning apparatus for cutting timbers, constructed in accordance with the present invention;

FIG. 2 is a top plan view illustrating the rotatable positioning apparatus for cutting timbers of FIG. 1, constructed in accordance with the present invention;

FIG. 3 is another top plan view illustrating the rotatable positioning apparatus for cutting timbers of FIG. 1, constructed in accordance with the present invention;

FIG. 4 is a side sectional view illustrating a rotatable turntable of the rotatable positioning apparatus for cutting timbers of FIG. 1, constructed in accordance with the present invention, with a load-bearing bearing;

FIG. 5 is a side sectional view illustrating the rotatable turntable of the rotatable positioning apparatus for cutting timbers of FIG. 1, constructed in accordance with the present invention, with an adjustable bullet bearing; and

FIG. 6 is a side sectional view illustrating a locking mechanism of the of the rotatable positioning apparatus for cutting timbers of FIG. 1, constructed in accordance with the present invention.

### DETAILED DESCRIPTION OF THE PREFERRED EMBODIMENTS

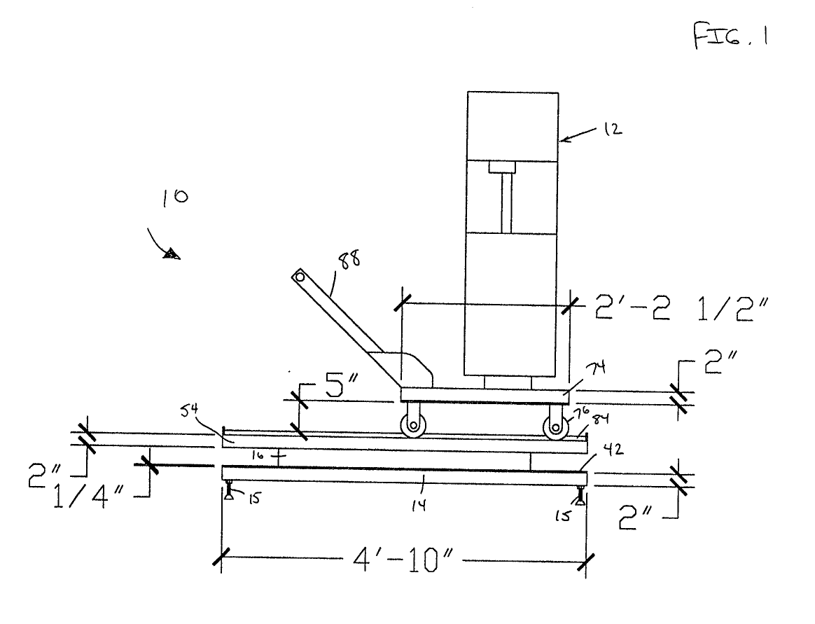

As illustrated in FIGS. 1, 2, and 3, the present invention is a rotatable positioning apparatus, indicated generally at 10, for cutting timbers (not shown), logs, and other wood products supported on a table (not shown) or other support. The rotatable positioning apparatus 10 supports a band saw 12 or the like for assisting a timber craftsperson in sizing and angling timbers and other wood used in constructing homes and other buildings and structures.

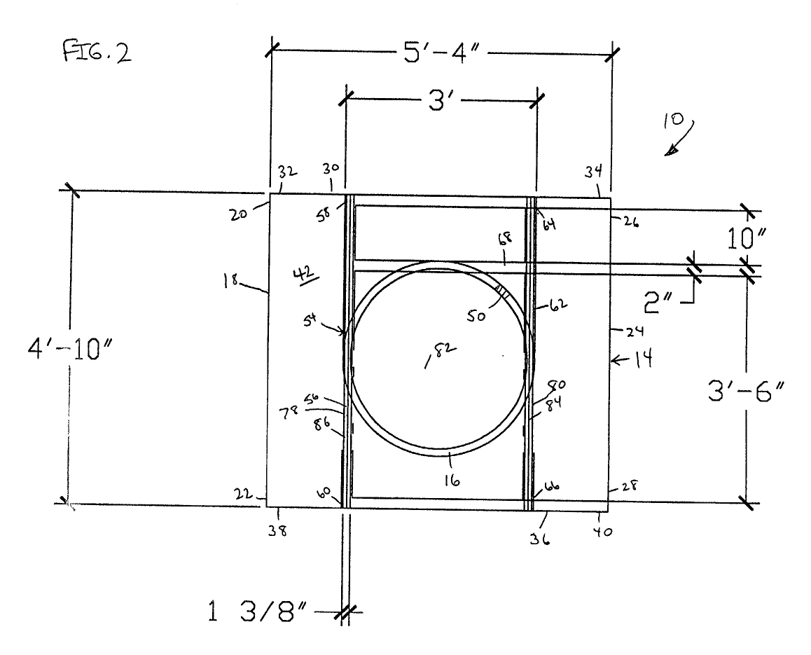

Now referring particularly to FIG. 2, the rotatable positioning apparatus 10 of the present application has a base frame 14 supporting a rotatable turntable 16. The base frame 14 includes a first end member 18 having a first end 20 and a second end 22, a second end member 24 having a first end 26 and a second end 28, a first side member 30 having a first end 32 and a second end 34, and a second side member 36 having a first end 38 and a second end 40. Preferably, the first end member 18, the second end member 24, the first side member 30, and the second side member 36 are constructed from a tubular steel material although constructing the first end member 18, the second end member 24, the first side member 30, and the second side member 36 from other types of material including, but not limited to, aluminum, wood, ceramic, etc., is within the scope of the present invention.

In the base frame 14 of the rotatable positioning apparatus 10 of the present invention, the second member 24 is substantially opposite and parallel to the first end member 18. The first end 32 of the first side member 30 is connected to the first end 20 of the first end member 18 and the second end 34 of the first side member 30 is connected to the first end 26 of the second end member 24. The second side member 36 is opposite the first side member 30 and is connected to the second end 22 of the first end member 18 and the second end 40 of the second end member 36. Preferably, the connection between the first end member 18, the second end member 24, the first side member 30, and the second side member 36 is a weld although other types of connections are within the scope of the present invention.

The base frame 14 further includes a sheet 42 of steel welded to the first end member 18, the second end member 24, the first side member 30, and the second side member 36. Preferably, the steel sheet 42 has a thickness of one-quarter (¼″) inch although a steel sheet 42 having a thickness greater than one-quarter (¼″) inch and less than one-quarter (¼″) inch is within the scope of the present invention. Furthermore, while the sheet 42 has been described as being constructed from a steel material, a person skilled in the art will understand that other materials including, but not limited to, aluminum, wood, ceramic, etc., can be used to construct the sheet 42. Preferably, the steel sheet 42 has the same dimensions as the constructed first end member 18, second end member 24, first side member 30, and second side member 36.

Referring back to FIG. 1, the base frame 14 additionally includes a plurality of adjustable feet 15. The adjustable feet are preferably mounted into the corners of the base frame 14. The adjustable feet 15 are adjustable for leveling the rotatable positioning apparatus and for raising the base frame 14 off the floor or other supporting surface.

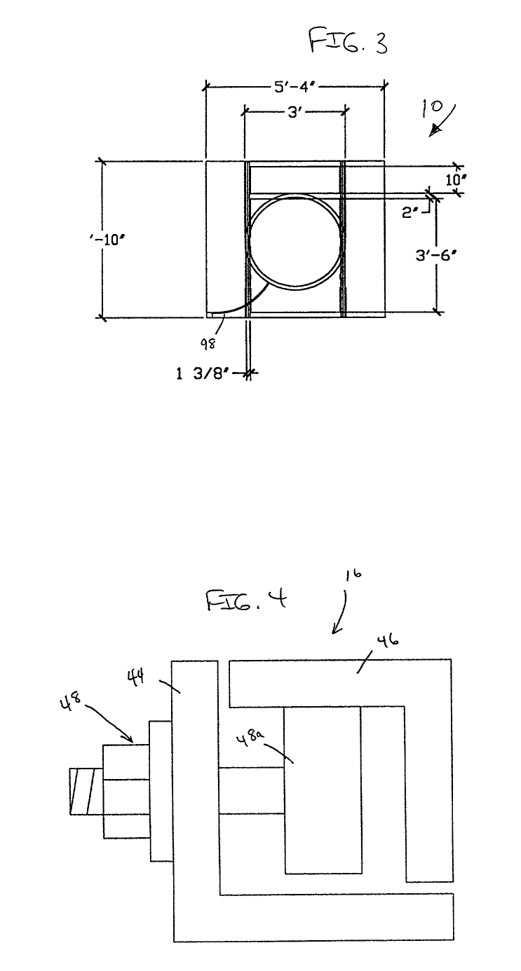

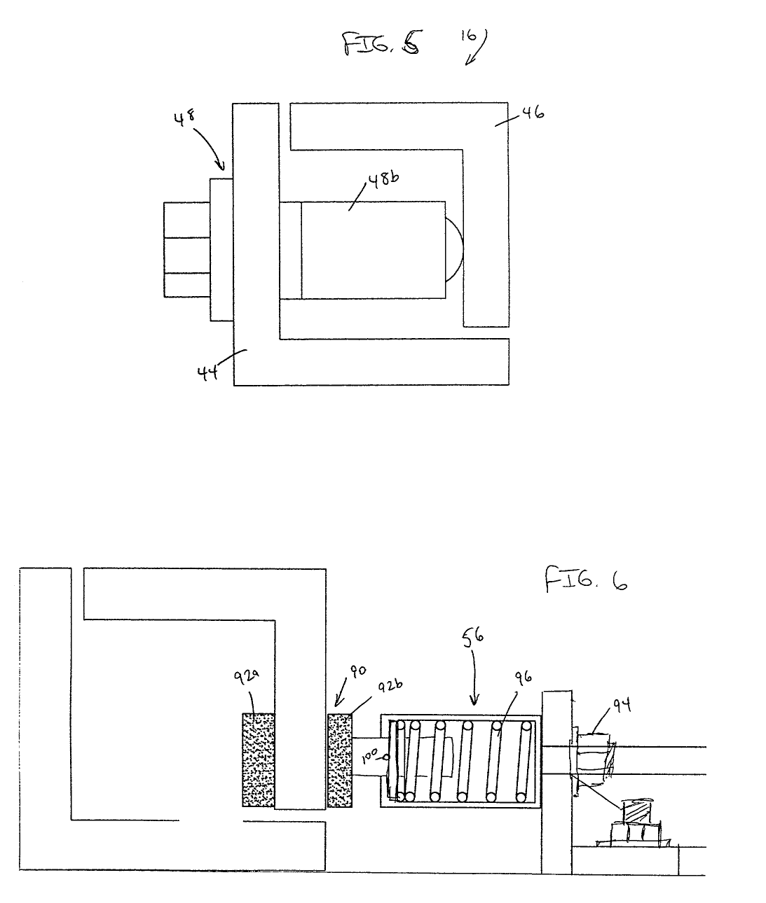

As illustrated in FIGS. 4 and 5, the rotatable turntable 16 of the rotatable positioning apparatus 10 of the present invention is preferably constructed from a first circular angle track 44 and a second circular angle track 46 with at least one bearing 48 secured therebetween. The first angle track 44 and the second angle track 46 are preferably constructed from an L-shaped angle iron with the second angle track 46 being inverted relative the first angle track 44. Each bearing 48 is secured between the first angle track 44 and the second angle track 46 to allow free three hundred and sixty (360°) movement of the second angle track 46 relative to the first angle track 44. Actual operation of the rotatable turntable 16 will be described in further detail below.

Still referring to FIGS. 4 and 5, in a preferred embodiment of the present invention, two different types of bearings 48 are employed for the rotatable positioning apparatus 10 of the present invention. The first bearing 48a is a load-supporting bearing. The first bearing 48a supports the load of the saw 12, as will be described in further detail below. The second bearing 48b is preferably a bullet bearing. The second bearing 48b maintains the second angle track 46 a predetermined distance from the first angle track 44 to allow free rotation of the second angle track 46 relative to the first angle track 44.

The rotatable turntable 16 is positioned on the top surface of the steel sheet 42 with the first angle track 44 secured to the steel sheet 42 with markings or other indicia 50 (as illustrated in FIG. 2, to indicate desired or predetermined cutting angles of the saw 12 on the timber. Once again, welding is the preferred method of securing the first angle track 44 of the rotatable turntable 16 to the base frame 14 although other methods of securing the first angle track 44 of the rotatable turntable 16 to the base frame 14 are within the scope of the present invention.

As illustrated in FIG. 6, the rotatable positioning apparatus 10 of the present invention also includes a locking mechanism 52 to releasably secure the rotatable turntable 16 in a desired position relative to the base frame 14. The locking mechanism 52 can be any type of locking mechanism 52 including, but not limited to, at least one clamp which clamps and releasably secures the rotatable turntable 16 to the base frame 14.

Still referring to FIG. 6, in a preferred embodiment of the present invention, the locking mechanism 52 includes an adjustable brake 90 secured to the base frame 14. The adjustable brake 90 has a first brake pad 92a and a second brake pad 92b with the first brake pad 92a and the second brake pad 92b clamping the second angle track 46 into a desired position relative to the first angle track 44. The adjustable brake 90 further includes an adjusting nut 94 for tensioning a spring 96 to a proper tension. A pin 100 can be used to maintain spring tension, if desired. As illustrated in FIG. 3, the adjustable brake 90 can be activated remotely by a remote control activation switch 98.

The rotatable positioning apparatus 10 of the present invention further includes a support frame 54 mounted to the rotatable turntable 16. The support frame 54 has a first frame member 56 having a first end 58 and a second end 60, and a second frame member 62 having a first end 64 and a second end 66. The second frame member 62 is substantially parallel to and opposite the first frame member 54. In a preferred embodiment, the first frame member 54 and the second frame member 62 are spaced apart from each other a distance substantially equal to the diameter of the rotatable turntable 16.

The support frame 54 further has a frame support member 68 connected between the first frame member 56 and the second frame member 62. The frame support member 68 further strengthens the support frame 54. Preferably, the frame support member 68 is connected to the first frame member 56 and the second frame member 62 by welding although connecting the frame support member 68 to the first frame member 56 and the second frame member 62 by other means including, but not limited to, bolts, rivets, screws, etc., is within the scope of the present invention.

As described above, the support frame 54 of the rotatable positioning apparatus 10 of the present invention is connected to the rotatable turntable 16. Preferably, the first frame member 56, the second frame member 62, and the frame support member 68 are welded to the second angle track 46 of the rotatable turntable 16 although other methods of connection are within the scope of the present invention. By connecting the support frame 54 to the rotatable turntable 16, the support frame 54 rotates freely relative to the base frame 14.

A first rail 84 and a corresponding substantially parallel second rail 86 are mounted to the first frame member 54 and the second frame member 62. The first rail 84 and the second rail 86 are preferably constructed from angle iron having a substantially L-shaped cross-sectional configuration, although constructing the first rail 84 and the second rail 86 from other materials having various cross-sectional configurations is within the scope of the present invention.

The rotatable positioning apparatus 10 of the present invention additionally includes a saw-supporting frame 74 for supporting the saw 12. The saw-supporting frame 74 is freely movable along the first rail 84 and the second rail 86 mounted to the support frame 54. To facilitate free lateral movement of the saw-supporting frame 74 along the support frame 54, the saw-supporting frame 74 has a plurality of grooved wheels 76. The grooved wheels 76 follow along the first rail 84 and the second rail 86 to allow linear movement of the saw-supporting frame 74 along the length of the support frame 54.

The saw-supporting frame 74 further has a first support member 78 and a second support member 80 for strengthening the saw-supporting frame 74 in supporting the saw 12. A strengthening frame 82 is connected between the first support member 78 and the second support member 80 for further strengthening the saw-supporting frame 74. Preferably, the saw-supporting frame 74 supports the saw 12 such that the bottom throat of the saw 12 is approximately the same height as the top of the table. This allows proper alignment of the saw 12 with the timber being cut. A plurality of bolts (not shown) can be used to releasably secure the saw 12 to the saw-supporting table 74.

Furthermore, the saw-supporting frame 74 includes a handle 88 extending in a general direction away from the saw 12. The handle 88 allows the craftsperson to maneuver the saw-supporting frame 74, and thus, the saw 12, into a proper, predetermined position without having to manually touch or otherwise contact either the saw-supporting frame 74 or the saw 12.

In operation, the timber or other lumber is positioned on the table with at least a portion of the timber cantilevered or otherwise overhanging an end of the table. The rotatable turntable 16 of the rotatable positioning apparatus 10 is rotated into a desired, predetermined position relative to the overhanging portion of the timber and releasably secured relative to the base frame 14 by the locking mechanism 52. The saw 12 positioned on the saw-supporting frame 74 is maneuvered along the first rail 84 and the second rail 84 mounted to the support frame 54 to cut and/or angle the timber according to the craftsperson's specifications.

The rotatable positioning apparatus 10 of the present invention allows a craftsperson to accurately position the saw in any position relative to the timber. The cutting of the timber to the proper length and angle can be accomplished quickly and accurately thereby inhibiting error. Reducing the time and increasing the accuracy of timber cutting reduces the time necessary in preparing the timbers for use in constructing the home or other building thereby reducing costs associated with the use of timbers in the building industry.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A rotatable positioning apparatus for cutting lumber to a predetermined length and a predetermined angle, the rotatable positioning apparatus supporting a saw, the rotatable positioning apparatus comprising:
a base frame;
a rotatable turntable mounted to the base frame;
a support frame mounted to the rotatable turntable, the support frame having a predetermined length;
a saw supporting frame movable along the length of the support frame, the saw being secured to the supporting frame; and
a locking mechanism for releasably securing the rotatable turntable in a predetermined position relative to the base frame.

2. The rotatable positioning apparatus of claim 1 wherein the rotatable turntable has an annular first member and an annular second member positioned within the annular first member, the annular first member being mounted to the base frame and the second annular member movable in substantially circular manner relative to the annular first member.

3. The rotatable positioning apparatus of claim 2 wherein the annular first member and the annular second member have a substantially L-shaped cross-sectional configuration.

4. The rotatable positioning apparatus of claim 3 and further comprising at least one bearing between the annular first member and the annular second member.

5. The rotatable positioning apparatus of claim 1 wherein the support frame has a first rail and a second rail, and further wherein the saw supporting frame has a plurality of wheels movable along at least a portion of the length of the first rail and the second rail.

6. The rotatable positioning apparatus of claim 5 wherein each wheel has a groove for receiving at least a portion of the first rail and the second rail.

7. The rotatable positioning apparatus of claim 1 wherein the locking mechanism has at least one clamp between the base frame and the rotatable turntable.

8. The rotatable positioning apparatus of claim 1 and further comprising:
indicia on the rotatable turntable for indicating an angle of the saw relative to the lumber.

9. An assembly for cutting a timber to a predetermined length and angle, the assembly comprising:
a rotatable turntable movable in a substantially circular manner;
rail means mounted to the rotatable turntable; and
saw means movable along the rail means for performing at least one cut on the timber at the predetermined length and angle;
wherein the saw means are movable in a substantially circular manner and a substantially linear manner relative to the timber.

10. The assembly of claim 9 and further comprising:
a base frame mounted to the rotatable turntable.

11. The assembly of claim 9 wherein the rotatable turntable has an annular first member and an annular second member positioned within the annular first member, the annular first member being mounted to the base frame and the second annular member movable in substantially circular manner relative to the annular first member.

12. The assembly of claim 11 wherein the annular first member and the annular second member have a substantially L-shaped cross-sectional configuration.

13. The assembly of claim 12 and further comprising at least one bearing between the annular first member and the annular second member.

14. The assembly of claim 9 wherein the rail means has a first rail and a second rail, and further wherein the saw means has a plurality of wheels movable along at least a portion of the length of the first rail and the second rail.

15. The assembly of claim 14 wherein each wheel has a groove for receiving at least a portion of the first rail and the second rail.

16. The assembly of claim 9 and further comprising:
a locking mechanism for releasably securing the rotatable turntable in a predetermined position.

17. The assembly of claim 16 wherein the locking mechanism is mounted to the base frame and has two different types of bearings.

18. The assembly of claim 17 and further comprising:
indicia on the rotatable turntable for indicating an angle of the saw means relative to the lumber.

19. A method for cutting a stationary timber to a predetermined length and angle, the method comprising:
providing a rotatable turntable movable in a substantially circular manner;
providing a parallel rail track;
mounting the parallel rail track to the rotatable turntable;
providing a saw mechanism movable along the rail means;
moving the saw mechanism in a substantially circular manner;
moving the saw mechanism in a substantially linear manner; and
for performing at least one cut on the timber at the predetermined length and angle.

20. The method for cutting of claim 19 and further comprising:
releasably securing the rotatable turntable in a predetermined position.
